(19) United States
(12) Patent Application Publication
(10) Pub. No.: US 2005/0217052 A1
(43) Pub. Date: Oct. 6, 2005

(54) Bracket assembly

(76) Inventor: Taurris D. Baskerville, Algonquin, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/143,842

(22) Filed: Jun. 2, 2005

Related U.S. Application Data
(63) Continuation-in-part of application No. 11/038,961, filed on Jan. 20, 2005.
(60) Provisional application No. 60/552,303, filed on Mar. 11, 2004.

(51) Int. Cl. B60S 1/32; B60S 1/02; B60S 1/04

(52) U.S. Cl. 15/250.19; 15/250.001

(57) ABSTRACT

A bracket assembly includes a bracket adapted to mount on one side of a panel and a threaded fastener including a female component mounted in a shaped hole of the panel and a male fastener component extending through the bracket and engaged with a bore in the female fastener component.

### CROSS-REFERENCE TO RELATED APPLICATIONS

The present U.S. patent application is a continuation-in-part of U.S. patent application Ser. No. 11/038,961, filed on Jan. 20, 2005, which claims the benefits of U.S. Provisional Application Ser. No. 60/552,303 filed Mar. 11, 2004.

### FIELD OF THE INVENTION

The present invention relates generally to assemblies, such as brackets that are mounted on an object through an opening in the object; and, more particularly, to rear wiper arm support bracket assemblies mounted through openings in body panels of automobiles.

### BACKGROUND OF THE INVENTION

Brackets and fixtures of different configurations are mounted on assemblies of various types. For example, brackets or fixtures are used to hold or support components. In automobiles brackets are used for a variety of purposes. Sport utility vehicles and other automobiles often provide a wiper arm on the rear window for clearing rain, snow and other moisture from the outer surface of the window. It is known to provide a support in the form of a bracket spaced some distance from the pivoting end of the wiper arm, so that the wiper arm has a support from underneath when the wiper is in an off or inactive state. The bracket is secured to the outer panel or tailgate of a sports utility vehicle or other vehicle.

It is known to secure rear wiper brackets by means of a riveting nut and threaded fastener whereby the riveting nut is inserted in an opening of the body panel, and then expanded to engage the panel at the opening. The bracket is secured to the riveting nut using a threaded fastener. In a known assembly process, the riveting nut is first attached to a tailgate panel by way of a riveting nut gun. Thereafter, the bracket, which may be of rubber, is positioned on the outside of the tailgate or other vehicle panel, and a screw is passed through the rubber bracket and threaded into the riveting nut to secure the rubber bracket to the tailgate. A driver of suitable type is used to tighten the screw in the nut. This known assembly process requires multiple distinct assembly steps. First a riveting nut must be acquired, positioned and secured to the panel. Thereafter, the bracket must be acquired and positioned relative to the nut fastened in the panel. Finally, the threaded fastener is passed through the bracket and into the nut, and then secured to the riveting nut. Two tools are required, a riveting nut gun for securing the nut in position, and an appropriate driver for turning the screw.

Although this known assembly for a rear wiper bracket support has proven to be satisfactory once assembled and ready for use, installation is somewhat cumbersome and time consuming. Known designs of this type are not conducive to pre-assembly of any portion. The final assembly and installation includes three individual parts, the riveting nut, the bracket and the screw to complete the assembly. As a result, assembly is somewhat awkward. Moreover, because three individual parts are required, separate inventories of each are needed and the individual parts must be gathered for completing an installation. This adds to the complexity of inventory control and vehicle assembly.

There is a need to improve rear wiper bracket assemblies to facilitate installation and to simplify parts inventory control in automobile assembly plants.

### SUMMARY OF THE INVENTION

The present invention provides a bracket assembly with components that can be pre-assembled prior to installation, and the pre-assembled unit installed as a single component.

In one aspect thereof, the present invention provides a bracket assembly for attachment to a panel having an opening with a larger first portion and a smaller second portion extending between a first side and a second side of the panel. The bracket assembly includes a bracket having a hole extending therethrough, a threaded fastener male component having a shank inserted through the hole, and a female component configured to partially enter the larger portion of the opening in the panel without passing completely therethrough. The female component is secured in the smaller portion of the opening, with a part of the female component on the first side of the panel and another part of the female component on the second side of the panel. A bore in the female component receives the male component in threaded engagement for drawing the bracket against the panel.

In another aspect thereof, the present invention provides a bracket assembly with a bracket having a shell and a core defining a hole therethrough. A male threaded fastener extends through the hole and has a head larger than the hole. A female component has a bore engaging the male threaded fastener. The female component has a larger first collar nearest the bracket, a second collar smaller than the first collar and more distant from the bracket relative to the first collar, and a channel between the collars.

In a further aspect thereof, the present invention provides a windshield wiper bracket assembly mounted on a vehicle panel having an opening between a first side of the panel and a second side of the panel. The panel has a keyhole opening with a substantially circular larger portion and a rectangular portion extending from the substantially circular portion. A female component has a bore and spaced collars, one of the collars being of a size and shape to pass through the substantially circular larger portion and the other of the collars being of a size and shape larger than the substantially circular larger portion. The collars are spaced from each other by a distance sufficient for receiving between them edges of the panel adjacent the rectangular portion of the keyhole opening. A bracket is configured for supporting a wiper arm, defines a hole and is configured for positioning against one side of the panel. A threaded fastener extends through the hole and has a threaded shaft for threaded engagement in the bore of the female component.

An advantage of the present invention is providing a rear wiper bracket assembly that can be pre-assembled and installed with a simple procedure requiring only a single step and one tool.

Still another advantage of the present invention is providing an object that can be secured to a panel in a fast, efficient manner.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a rear wiper bracket assembly in accordance with the present invention, illustrating the assembly in a condition of readiness for installation on a panel of a vehicle;

FIG. 2 is a perspective view of the bracket assembly shown in FIG. 1, but illustrating the bracket assembly from a different angle to expose the back of the assembly;

FIG. 3 is an elevational view of the bracket assembly and a panel in which the assembly is placed, showing an early stage of the installation of the assembly in the panel, with the panel being shown in cross-section;

FIG. 4 is a perspective view of the back of the bracket assembly, illustrating the condition of the assembly when tightened, but not showing the assembly installed in a panel;

FIG. 5 is an elevational view of the bracket assembly and panel similar to that of FIG. 3, but illustrating the condition of each when the bracket assembly is fully installed in the panel; and

FIG. 6 is a plan view of a segment of a panel in which the bracket shown in the preceding views can be installed.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

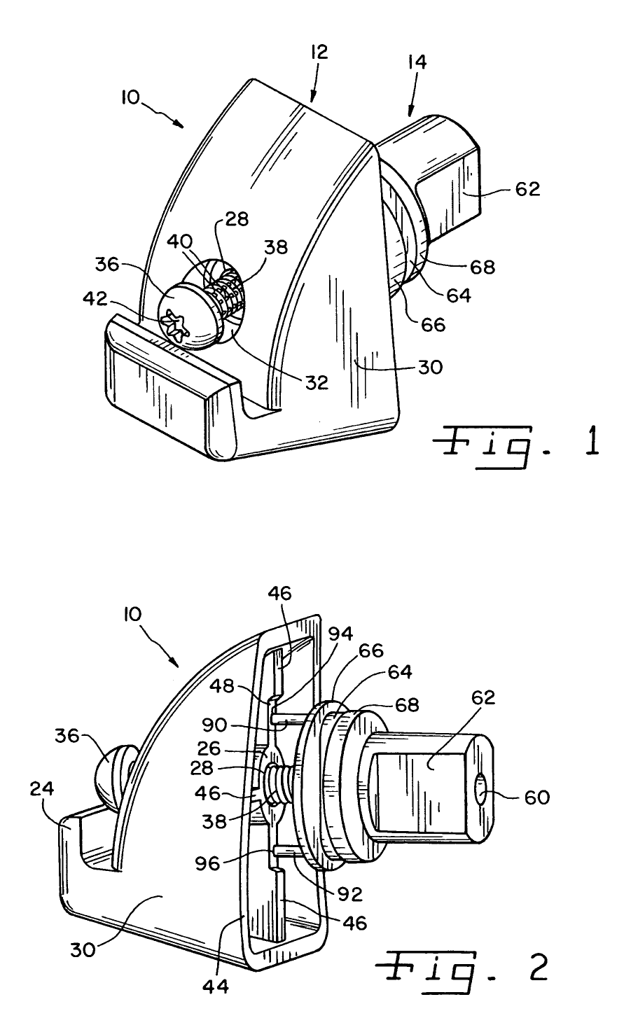

Referring now more specifically to the drawings and to FIG. 1 in particular, numeral 10 designates a rear wiper bracket assembly in accordance with the present invention. Bracket assembly 10 is illustrated and has particular utility as a wiper arm support bracket for a rear wiper on an automobile such as a sports utility vehicle or the like. However, features of the present invention can be incorporated into mounting assemblies for mounting other assemblies on other objects. Use in automobiles and specific use for rear wiper supports are exemplary only and are not the only uses for the present invention.

Bracket assembly 10 includes a bracket 12 and a threaded fastener 14. Fastener 14 has a threaded male component 16 extending through bracket 12, and a female component 18 in which male component is received and secured. Male component 16 and female component 18 cooperate with each other and with bracket 12 to secure bracket assembly 10 through an opening 20 in a panel 22 (FIG. 6). A gasket (not shown) can be disposed between bracket 12 and panel 22 to provide a weather-tight seal against moisture and other contaminants migrating through opening 20. Bracket 12 and fastener 14 can be made of metal, plastic or other suitable material, and need not be of the same material. For example, bracket 12 can be rubber, and all or parts of fastener 14 can be metal or plastic.

In the exemplary structure shown, bracket 12 is the support body on which a rear wiper arm (not shown) of a vehicle can rest. To that end, bracket 12 defines a lip 24 for engaging the wiper arm (not shown). The general outer configuration of bracket 12 and lip 24 can be changed for aesthetic and/or functional purposes, and the present invention can be used for attaching things other than wiper arm brackets on structures other than automobiles.

Bracket 12 has a core 26 defining a hole 28 therethrough extending from an exposed outer first side 28 thereof shown in FIG. 1 to a second inner side thereof nearest and against panel 22 when assembly 10 is installed. FIG. 2 shows male component 16 extending outwardly of the second side of bracket 12, with female component 18 on that end of male component 16. Bracket 12 includes an outer shell 30 defining an enlarged cavity 32 at the entrance to hole 28 exposed on the outer side of bracket 12.

Male component 16 includes a shank 34 and a head 36. A male thread 38 on shank 34 can be provided with surface formations 40 in the way of depressions to improve engagement with and retention in female component 18. Head 36 is configured for engaging a tool whereby male component 16 is rotated. Accordingly, head 36 can be provided with an orifice 42 shaped to receive a driver therein, such as a screwdriver of various configurations, a hex-driver or other suitable hand or power tool. Alternatively, head 36 can be configured at the periphery thereof to be engaged by a tool such as a socket, nut driver or other wrench. Male component 16 is inserted into hole 28 of core 26 from the exposed first side of shell 30, through cavity 32. Cavity 32 forms a depression at the entrance to hole 28 of sufficient size and shape to receive head 36 therein, when fastener 14 is tightened.

As illustrated in FIG. 2, bracket 12 is substantially hollow for reducing weight and material. At the second or inner side, shell 30 defines an edge 44 to be engaged against panel 22 when assembly 10 is installed. Various supports 46 extend between core 26 and outer shell 30 for strength and rigidity. Core 26 and at least a portion of edges of supports 46 are recessed inwardly relative to edge 44, thereby forming a nest 48 for partially receiving female component 18 therein, as will be described in greater detail hereinafter.

Female component 18 is configured for threaded engagement with male component 16. Accordingly, female component 18 defines a bore 60 having sufficient length to engage a sufficient portion of male thread 38 to clamp bracket assembly 10 to panel 22, as will be described more completely hereinafter. Bore 60 can be slightly narrower than male thread 38, with male thread 38 being configured as a self-tapping thread for cutting into and engaging material defining bore 60. Alternatively, bore 60 may be threaded for threaded engagement with male thread 38. A distal portion 62 of the female component 18 can be configured for engagement by a wrench or other tool to stabilize female component 18 when male component 16 is rotated therein.

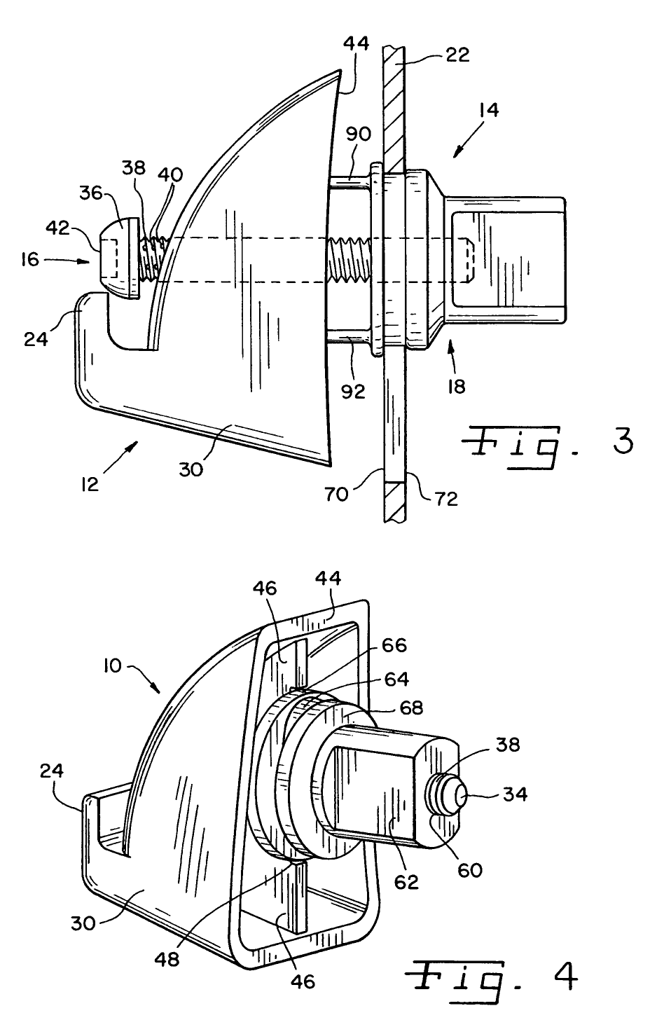

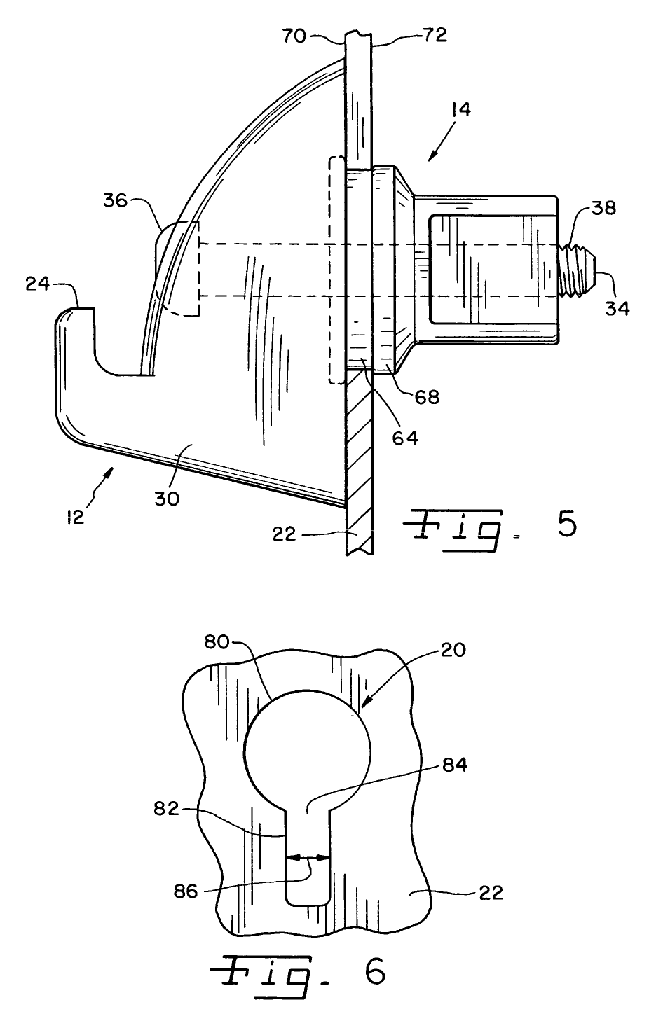

An end of female component 18 adjacent bracket 12 defines a channel 64 between first and second collars 66 and 68. Collar 68 is inwardly on female component 18 relative to channel 64 and collar 66. Collar 66 is of slightly larger diameter than collar 68. The space between collar 66 and collar 68, that is, the width of channel 64, is substantially similar to a width of panel 22, as illustrated best in FIGS. 3 and 5, so that panel 22 fits relatively snuggly in channel 64, between collars 66 and 68. In the exemplary embodiment shown, channel 64 surrounds female component 18, but is not circular, instead having flattened lengths on opposite sides of female component 18.

Opening 20 extends through panel 22 from a first side 70 of panel 22 to a second side 72 of panel 22. Opening 20 is a so-called “keyhole” shaped opening having a larger first portion 80 and a smaller second portion 82 radiating from first portion 80. In the exemplary embodiment show in FIG. 6, first portion 80 is substantially round, and second portion 82 is a rectangular portion or slot 82 having an opening or entrance 84 thereto from first portion 80. First portion 80 is of a diameter slightly larger than the diameter of collar 68 but slightly less than the diameter of collar 66. Accordingly, collar 68 can be inserted through first portion 80 of opening 20, but collar 66 cannot be passed through or into portion 80. Other coordinated shapes for first portion 80 and collar 68 can be used, which allow collar 68 to be passed through opening 20. A round first portion 80 and round collar 68 are advantageous in that collar 68 can enter first portion 80 if properly aligned axially, regardless of the rotational orientation of female component 18.

Slot-shaped second portion 82 has a width designated by arrowed line 86 of sufficient dimension to receive and engage female component 18, with the edges of second portion 82 being received in channel 64. As described previously, collars 66 and 68 and channel 64 are configured advantageously so that channel 64 is not round but instead elongated, having a longer length and a narrower width. Configured in that manner, female component 18 will slide into second portion 82 in only two positions diametrically opposite each other. Since only one of those diametrically opposed positions properly orients shell 30 and lip 24, bracket assembly 10 can be oriented visually for proper installation. Alternatively, if channel 64 is configured annularly, female component 18 can be engaged into second portion 82 of an appropriate width at any rotational position of female component 18.

In use, bracket assembly 10 can be shipped in pre-assembled form as illustrated in FIGS. 1 and 2, with threaded fastener 14 loosely assembled to bracket 12. Male component 16 is inserted into hole 28 of core 26 as described previously, and a portion of the distal end of shank 34 is inserted into and engaged with bore 60 of female component 18. In a pre-assembled form as shown, final installation on a vehicle is facilitated in that only one pre-assembled component need be acquired, positioned and attached to panel 22.

To attach the pre-assembled bracket assembly 10 to panel 22, female component 18 is aligned with first portion 80 of opening 20. Distal end portion 62 and collar 68 are inserted into and through first portion 80 of opening 20. Since collar 66 is of greater diameter than first portion 80 of opening 20, collar 66 cannot be inserted into or through first portion 80, but instead abuts against panel 22. Accordingly, an installer can quickly determine when a sufficient portion of female component 18 has been passed through opening 20 such that channel 64 is aligned with second portion 82. The position thus far described is shown in FIG. 3.

From the position shown in FIG. 3, bracket assembly 10 is moved toward second portion 82 such that the peripheral edges of second portion 82 are received in channel 64, between collars 66 and 68. As thus positioned, bracket assembly 10 cannot be moved inwardly or outwardly relative to panel 22 in that panel 22 is sandwiched between collars 66 and 68.

Bracket assembly 10 is secured in position by use of a tool or driver engaged with head 36 of male component 16 by which male component 16 is rotated to draw male thread 38 of shank 34 further into bore 60 of female component 18. In this manner, male component 16 is drawn into female component 18 until edge 44 of shell 302 engages a surface of panel 22. Further tightening of male component 16 further compresses the assembly of bracket assembly 10 and panel 22. Nest 48 provides a recessed area in which collar 66 is received, thereby allowing edge 44 to rest flush against panel 22. Head 36 settles into cavity 32 in an accessible, yet out of the way position. The final installed position is shown in FIG. 5. If necessary during final tightening, a wrench or other tool can be engaged against distal portion 62 of female component 18 to limit the rotation of female component 18 as male component 16 is turned for tightening. Bracket 12 is thereby held securely in its operative position relative to panel 22, with the assembly thereof onto panel 22 requiring only a simple operation for installing and tightening.

As described previously, channel 64 in female component 18 can be configured advantageously such that proper orientation is required for moving female component 18 to a position in which it engages second portion 82 of opening 20. To ensure that bracket 12 is properly oriented with respect to female component 18, a telescopic fixture arrangement can be used between female component 18 and bracket 12. As illustrated in FIGS. 2 and 3, female component 18 includes first and second pins 90 and 92 telescopically received in tunnels 94, 96 of supports 46. Thus, female component 18 is properly oriented with respect to bracket 12 during the pre-assembly of bracket assembly 10. The desired orientation of bracket 12 and lip 24 thereof can be used for aligning the pre-assembled bracket assembly 10 with panel 22 and second portion 82 thereof as female component 18 is moved from an initial position in first portion 80 of opening 20 to the final position in second portion 82.

As illustrated in FIG. 3, edge 44 of side 30 can be provided slightly concave from top to bottom thereof. When tightened against panel 22, bracket 12 and specifically edge 44 flattens against panel 22. The biasing or spring-like effect provided thereby inhibits loosening of male component 16 in female component 18 from vibration or the like.

With female component 18 locked into second portion 82, even if male component 16 is loosened and removed, female component 18 remains in proper position in panel 22. Female component 18 can be removed from panel 22 only if collar 68 is precisely aligned with first portion 80 of opening 20. Since collar 66 is larger than any portion of opening 20, female component 18 cannot fall inwardly between door panels or the like.

In some uses of the present invention, a relatively vertical orientation of first portion 80 above second portion 82 is advantageous for receiving and holding female component 18 therein. However, it should be understood that the present invention is not limited to a vertical relationship between first and second portions 80 and 82. Horizontal and other angular relationships between vertical and horizontal also can be used, as well as orientations with second portion 82 above first portion 80

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A bracket assembly for attachment to a panel having an opening with a larger first portion and a smaller second portion extending between a first side and a second side of the panel, said bracket assembly comprising:
a bracket having a hole extending therethrough;
a threaded fastener male component having a shank inserted through said hole, said shank having a male thread thereon;
a female component configured to partially enter the larger portion of the opening in the panel without passing completely therethrough and to be secured in the smaller portion of the opening, with a part of said female component on the first side of the panel and another part of the female component on the second side of the panel; and
a bore in said female component receiving said male component in threaded engagement with said male thread for drawing said bracket against the panel.

2. The bracket assembly of claim 1, said threaded fastener having a self-tapping thread.

3. The bracket assembly of claim 1, said female component having a first collar larger than the larger first portion of the opening in the panel, a second collar smaller than the larger first portion of the opening and a channel between said first and second collars.

4. The bracket assembly of claim 3, said bracket having a side confronting the panel and defining a recessed nest in said side confronting the panel for receiving said first collar therein.

5. The bracket assembly of claim 3, said male component having a head configured for engaging a tool to rotate said male component.

6. The bracket assembly of claim 5, said head having an orifice for engaging a tool.

7. The bracket assembly of claim 5, said bracket defining a cavity for receiving said head.

8. The bracket assembly of claim 1, said bracket having an edge confronting the panel, said edge being concave surface for compression against the panel.

9. The bracket assembly of claim 1, said female component having pins extending toward said bracket, and said bracket having tunnels receiving said pins telescopically.

10. A bracket assembly, comprising:
a bracket having a shell and a core defining a hole therethrough;
a male threaded fastener extending through said hole and having a head larger than said hole; and
a female component having a bore engaging said male threaded fastener, said female component having a larger first collar nearest said bracket, a second collar smaller than said first collar and more distant from said bracket relative to said first collar, and a channel between said collars.

11. The bracket assembly of claim 10, said bracket having a side confronting said first collar and defining a recessed nest therein for receiving said first collar.

12. The bracket assembly of claim 11, said side of said bracket having an outer edge, and said edge being concave.

13. The bracket assembly of claim 12, said female component having pins extending toward said bracket, and said bracket having tunnels receiving said pins telescopically.

14. The bracket assembly of claim 10, said female component having pins extending toward said bracket, and said bracket having tunnels receiving said pins telescopically.

15. The bracket assembly of claim 10, said bracket having a side confronting said first collar and an outer edge of said side being concave.

16. The bracket assembly of claim 10, said bracket being configured for supporting a wiper arm on a motor vehicle.

17. A windshield wiper bracket assembly mounted on a vehicle panel having an opening between a first side of the panel and a second side of the panel, said windshield wiper bracket assembly comprising:
the panel having a keyhole opening therethrough, said keyhole opening having a substantially circular larger portion and a rectangular portion extending from said substantially circular portion;
a female component having a bore and spaced collars, one of said collars being of a size and shape to pass through said substantially circular larger portion and the other of said collars being of a size and shape larger than said substantially circular larger portion, said collars being spaced from each other by a distance sufficient for receiving therebetween edges of the panel adjacent said rectangular portion of said keyhole opening;
a bracket configured for supporting a wiper arm, said bracket defining a hole and being configured for conforming to a side of the panel when tightened against the panel; and
a threaded fastener extending through said hole and having a threaded shaft for threaded engagement in said bore of said female component.

18. The windshield wiper bracket assembly of claim 17, said bracket having a side confronting said other collar and defining a recessed nest therein for receiving said other collar.

19. The windshield wiper bracket assembly of claim 17, said bracket having a side confronting said other collar and said side being concave.

20. The windshield wiper bracket assembly of claim 17, said female component having pins extending toward said bracket, and said bracket having tunnels receiving said pins telescopically.

21. The windshield wiper bracket assembly of claim 17, said threaded shaft having a thread-forming thread.
